(19) United States
(12) Patent Application Publication
(10) Pub. No.: US 2007/0061777 A1
(43) Pub. Date: Mar. 15, 2007

(54) System, method, and computer program product for graphically generating a program for controlling the operation of a kiosk

(75) Inventors: Snehal Vashi, Smyrna, GA (US); Rodney Smith, Marietta, GA (US); Lisa Marie Foley, Atlanta, GA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: SOURCE TECHNOLOGIES, LLC

(21) Appl. No.: 11/223,348

(22) Filed: Sep. 9, 2005

(51) Int. Cl. G06F 9/44

(52) U.S. Cl. 717/113; 717/105; 717/109

(57) ABSTRACT

A system, method, and computer program product enable a user to graphically create a program for controlling operation of a self-service kiosk. A workflow diagram, representing the desired operation of the kiosk, is created in response to the selection and ordering by the user of a plurality of state elements and connector elements. The state elements define the input of data to and/or the output of data from the kiosk. The connector elements define the transition from one state element to another state element. When the workflow diagram is complete, a screen flow simulation may be created, comprising simulated kiosk screen displays. The screen flow simulation replicates the operation of the kiosk, thus enabling the user to test the planned operation prior to creating the final screen displays. When the user is satisfied with the screen flow simulation, the program for controlling operation of the kiosk may be created.

### FIELD OF THE INVENTION

Embodiments of the invention relate generally to self-service kiosks, and more particularly, to systems, methods, and computer program products capable of graphically creating a program for controlling the operation of a kiosk.

### BACKGROUND OF THE INVENTION

Self-service kiosks enable businesses to provide around the clock services to customers, in many convenient locations, without the expense of employing many people. As such, the use of self-service kiosks is greatly increasing. Self-service kiosks may be used, for example, to provide travel and tourism information or for purchasing and/or delivering theater tickets. One of the main uses for self-service kiosks is to provide financial services, such as remote bill paying.

The customer interface of self-service kiosks, particularly the screen flow, must be carefully planned to ensure the customer can quickly and easily accomplish the desired activity. The visual aspects of the screens, such as the graphics, text, and colors, are also important to ensure a pleasant experience for the customers. Owners of such self-service kiosks may frequently modify the flow and visual aspects of the screens, in a continual effort to ensure efficiency and to maintain a timely and modem appearance.

Current kiosk programming techniques typically begin by creating the visual aspects of the screen displays, using software such as Macromedia Flash™ or hypertext markup language (HTML). For a typical kiosk, this may entail creating approximately 30-50 screen displays. After the screen displays are created, the program to control the operation of the kiosk would typically be created. This program may be written using, for example, the eXtensions for Financial Services (XFS) programming standard. This program will typically control the presentation of screen displays on the kiosk, the communication with a centralized support system, and the operation of the kiosk peripheral devices. The peripheral devices in a kiosk may include, for example, a magnetic card stripe reader (“card reader”), a magnetic ink character recognition (MICR) scanner (“check reader”), a personal identification number (PIN) entry keypad (“PIN pad”), and a bar code reader.

This typical method of kiosk programming may not be efficient, particularly if many revisions need to be made to the program. As the program is being created to work with the previously created screen displays, the programmer may determine the planned order of display of the screens does not work or is not as efficient as possible. Or the programmer may discover that some screen displays must be modified to present different or additional information to a kiosk customer or to request different or additional information from the kiosk customer. The need for revisions to the program and/or to the screen displays may not be discovered until the program and the screen displays are complete and are being tested. The creation of the screen displays may be a-time consuming, and therefore expensive, task. Having to make multiple revisions to the screen displays may significantly increase the cost. Because of this, it would be desirable to be able to complete the kiosk program and verify proper operation before creating the screen displays.

### BRIEF SUMMARY OF THE INVENTION

A system, method, and computer program product are therefore provided that enable a user to graphically create a program for controlling operation of a kiosk. A workflow diagram, representing the desired operation of the kiosk, is created in response to the selection and ordering by the user of a plurality of state elements and a plurality of connector elements. The state elements define the input of data to and/or the output of data from the kiosk and typically correspond to one individual kiosk screen display. A predefined input variable may be associated with a state element to enable the kiosk to interface with any standard kiosk peripheral device. The connector elements define the transition from one state element to another state element, and thus define the order in which the kiosk screens are displayed (i.e., the screen flow). When the workflow diagram is complete, a screen flow simulation may be created, comprising simulated kiosk screen displays. The screen flow simulation replicates the operation of the kiosk, thus enabling the user to test the planned operation prior to creating the final screen displays. When the user is satisfied with the screen flow simulation, the program for controlling operation of the kiosk may be created. The created screen displays can be graphically enhanced to create the desired visual appearance.

In this regard, a system for graphically creating a program for controlling operation of a kiosk comprises a processing element. The processing element is capable of providing a library of state elements and connector elements, with each state element selected from the group comprising an input state and an output state. Each input state may define a receipt of data from a source that is external to the kiosk and further define at least one input variable having an input variable type. Each output state may define a provision of data to a recipient that is external to the kiosk and further define at least one output variable having an output variable type. Each connector element may be selected from the group comprising an unconditional connector and a conditional connector and may define a transition from a first state element to a second state element. The processing element may be further capable of creating a workflow diagram in response to a selection and ordering by a user of a plurality of state elements and a plurality of connector elements, with the workflow diagram representing a desired operation of the kiosk. The processing element may be further capable of creating a screen flow simulation corresponding to the workflow diagram, with the screen flow simulation comprising a plurality of simulated kiosk screen displays, and each simulated kiosk screen display corresponding to either an input state element or an output state element in the workflow diagram. The processing element may be further capable of creating the program for controlling operation of the kiosk in response to an acceptance by the user of the screen flow simulation, with the program comprising actual kiosk screen displays capable of being graphically enhanced.

In one embodiment, each state element is selected from the group further comprising a transactional state, wherein a transactional state defines a communication with a centralized support system. The centralized support system may be capable of performing at least one of verifying user account status, verifying a user personal identification number (PIN), and providing user account information. In such an embodiment, each simulated kiosk screen display may correspond to an input state element, an output state element, or a transactional state element in the workflow diagram.

Each input state may further define at least one output variable having an output variable type. The input variable type and the output variable type may both be selected from the group comprising integer, string, Boolean, floating point, globally unique identifier (GUID), card reader data, check reader data, pin pad data, and bar code data. In one embodiment, the program for controlling operation of the kiosk further comprises a standardized peripheral device interface routine if the input variable type is card reader data, check reader data, pin pad data, or bar code data. The processing element may create the standardized peripheral device interface routine using an extensions for financial services (XFS) software standard.

The conditional connector may define at least one input variable condition or at least one output variable condition, wherein the input or output variable condition defines under what condition the first state element transitions to the second state element.

In addition to the system for graphically creating a program for controlling operation of a self-service kiosk as described above, other aspects of the invention are directed to corresponding methods and computer program products for graphically creating a program for controlling operation of a self-service kiosk.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a flowchart of the operation of graphically creating a program for controlling operation of a self-service kiosk, according to one embodiment of the invention;

FIG. 2 is an illustration of a workflow diagram created by a system for graphically creating a program for controlling operation of a self-service kiosk, according to one embodiment of the invention;

FIG. 3 is an illustration of a template for a screen display simulation created by a system for graphically creating a program for controlling operation of a self-service kiosk, according to one embodiment of the invention;

FIG. 4 is an illustration of a screen display simulation created by a system for graphically creating a program for controlling operation of a self-service kiosk, according to one embodiment of the invention;

FIG. 5 is an illustration of an actual screen display created from the simulated screen display of FIG. 4, according to one embodiment of the invention; and

FIG. 6 is a schematic block diagram of a system for graphically creating a program for controlling operation of a self-service kiosk, according to one embodiment of the invention.

### DETAILED DESCRIPTION OF THE INVENTION

Embodiments of the invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

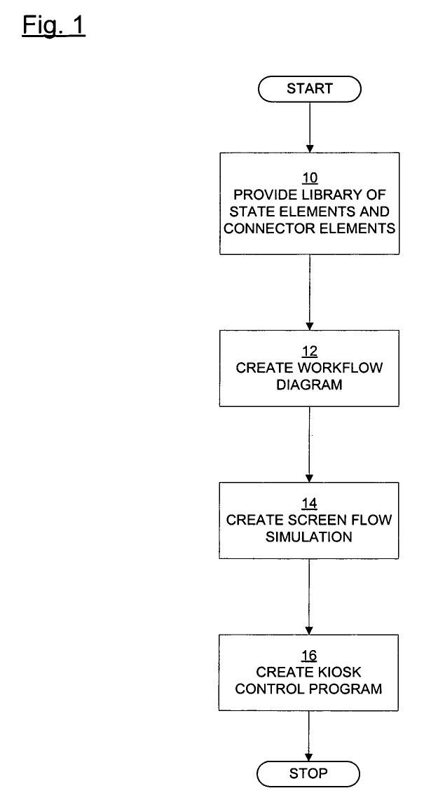

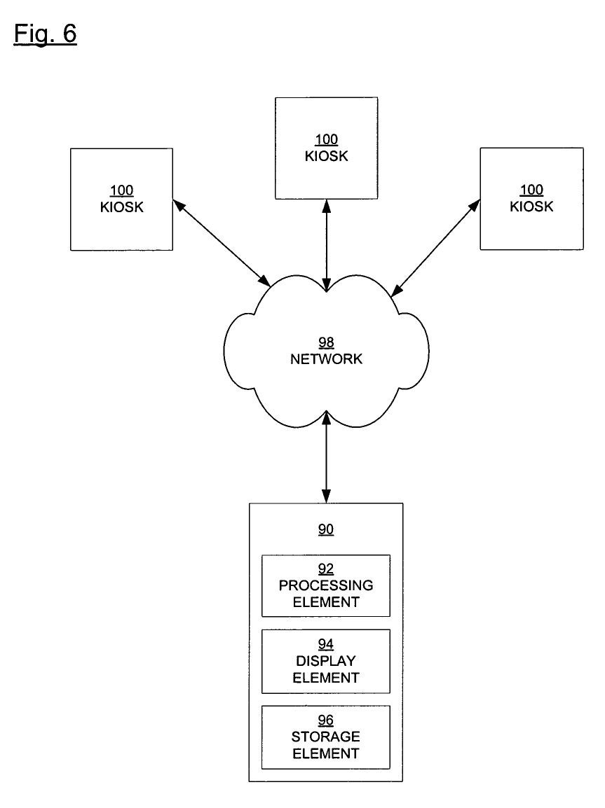

FIG. 1 is a flowchart of the operation of graphically creating a program for controlling operation of a self-service kiosk, according to one embodiment of the invention. A library of state elements and connector elements may be provided, such as by processing element 92 of FIG. 6, to enable a user to define a workflow diagram. See block 10 of FIG. 1. The library of elements may be provided as predefined shapes within a template in a flowcharting software package, such as Microsoft Visio™. A workflow diagram is a representation of a desired sequence of events, actions, and screen displays that may occur during a customer transaction at a self-service kiosk, including the input of data from outside the kiosk and the output of data from inside the kiosk. A state element represents an interaction between the kiosk and a person (e.g., a customer), a system (e.g., a backend server), and/or a peripheral device (e.g., a card reader). A state element also typically corresponds to a kiosk screen display that a customer may encounter during a transaction. There is typically a one-to-one relationship of kiosk display screens to state elements. In one embodiment of the invention, three types of state elements are provided in the library: input state elements, output state elements, and transaction state elements. An input state element generally requires the customer to provide data to the kiosk, such as by entering a PIN using a PIN pad, swiping a magnetic stripe on a debit or credit card, scanning the MICR data on a check, scanning a bar code, or entering an account number using a numeric keypad. An input state element may also be used to provide data to the customer, as discussed in detail below. An output state element generally provides data to the customer, such as by displaying a message on the kiosk display device or by printing a receipt. A transaction state element generally causes the kiosk to communicate with a centralized support system, such as a backend server, to verify data provided by the customer (e.g., account number and/or PIN) or to receive information necessary to complete the transaction (e.g., the payment amount due on the customer's account).

Each state element may define one or more variables that control the data input to and/or output from the state element. In one embodiment of the invention, a state element may define input variables or may define both input variables and output variables. Additionally, transaction state elements may have one or more variables that are specific only to transaction states. Input variables are generally used to present options, actions, or data input requests to a customer. For example, an input variable may be used to present the customer with an option to continue to the next screen display or to cancel the transaction, or to request that the customer input an account number. Input variables may be defined by either an input state element or a transaction state element. Each input variable will typically have an input variable type. The input variable type specifies what type of input is expected. In one embodiment, the input variable types include: integer (i.e., a whole number), string (i.e., text), Boolean (i.e., true or false), float (i.e.,.number that includes a decimal point), global unique identifier (“GUID”) (i.e., a unique number identifying a device), address (may include street address, city, state, and zip/postal code), name (may include first name, middle name, last name, and surname), card reader data (may include card number, expiration data, name, raw data, and extra data), check reader data (may include account number, amount, check back image, check front image, check number, raw data, and routing number), PIN pad data (may include encrypted PIN, raw data, and security information), and bar code data (may include data, format, and product). Importantly, several of the input variable types (e.g., card reader data, check reader data, PIN pad data, and bar code data) may be used to specify an interaction with a corresponding standardized peripheral device (e.g., card reader, check reader, PIN pad, and bar code reader). Selecting an input variable with such an input variable type may cause the system, method, and computer program product of the invention to create a standardized peripheral device interface routine within the kiosk control program.

Output variables define the data to be presented to a customer, such as by displaying on a screen display or by printing on a receipt. The data that is presented may be data that was entered by the customer (e.g., the account number entered by the customer may be displayed on the screen display), data that was returned from a backend server (e.g., the customer's account balance), or data that was otherwise generated during the transaction (e.g., a confirmation number may be printed on a receipt). Output variables may be defined by an input state element, an output state element, or a transaction state element. Each output variable will typically have an output variable type. The output variable type specifies what type of output is expected. In one embodiment, the output variable types include: integer (i.e., a whole number), string (i.e., text), Boolean (i.e., true or false), float (i.e., number that includes a decimal point), global unique identifier (“GUlD”) (i.e., a unique number identifying a device), address (may include street address, city, state, and zip/postal code), name (may include first name, middle name, last name, and surname), card reader data (may include card number, expiration data, name, raw data, and extra data), check reader data (may include account number, amount, check back image, check front image, check number, raw data, and routing number), PIN pad data (may include encrypted PIN, raw data, and security information), and bar code data (may include data, format, and product). Importantly, several of the output variable types (e.g., card reader data, check reader data, PIN pad data, and bar code data) may be used to specify an interaction with a corresponding standardized peripheral device (e.g., card reader, check reader, PIN pad, and bar code reader). Selecting an output variable with such an output variable type causes the system, method, and computer program product of embodiments of the invention to create a standardized peripheral device interface routine within the kiosk control program.

As mentioned above, transaction state elements may have one or more variables that are specific only to transaction states. In one embodiment of the invention, there are two transaction state variables: a result variable (which may also be termed an input variable) and an external service variable. The transaction state element may also have one or more properties, such as an external reference property. The result (or input) variable typically defines the output expected from the backend server. In one embodiment, there are two default result variables: success and valid. The success variable indicates whether the backend server was able to receive the variable (e.g., an account number or PIN) sent from the kiosk and check the validity (e.g., whether the account number sent from the kiosk is recognized by the backend server as an account number that can be checked). The valid variable indicates whether the variable sent from the kiosk is determined by the backend server to be valid (e.g., whether the checked account number corresponds to a valid account). Both of these default result variables will typically have a variable type of Boolean. The external reference property typically defines a GUID of the backend server (e.g., “ValidationServer”). The external service variable typically defines the action that the backend server will take (e.g., “CheckCard”).

A connector element defines a transition from one state element (which may be termed the “From” state element) to another state element (which may be termed the “To” state element). In one embodiment of the invention, two types of connector elements are provided in the library: standard and stub. Either type of connector element may be configurable by the user as an unconditional connector element or a conditional connector element. An unconditional connector element generally transitions from a first state element to a second state element in all transactions in which the first state element is encountered. A conditional connector element generally transitions from a first state element to a second state element upon the satisfaction of one or more predefined conditions. A conditional element is generally used to determine which of two or more subsequent state elements (and therefore which of two different kiosk screen displays) are reached based on the information provided or selection made at the previous state element (screen display). For example, if a customer's account status is validated during the course of a transaction and the backend server returns a status of “inactive,” the transaction would typically continue to a different screen display than if the backend server returns a status of “active.”

The condition for a conditional connector element is typically constructed using an input or output variable, an operator (e.g., =, <,>, ≦, or ≧), and a value. The value specified in the condition will typically correspond to the type of variable. For example, if the variable in the condition is a Boolean variable, then the value will typically be either “true” or “false.” If the variable in the condition is an integer variable, then the value will typically be an integer. A conditional connector may have more than one condition. In one embodiment of the invention, multiple conditions may be joined using the Boolean operators “and” or “or” (the Boolean operators may be represented by symbols, such as “&&” for “and”). The Boolean operators joining the multiple conditions typically indicate whether all or some of the multiple conditions need to be satisfied to cause the transition indicated by the connector element.

A standard connector element will typically be visually connected to two state elements (a From state element and a To state element). However, as the workflow diagram grows in size and complexity, visually connecting one state element with another state element may cause the workflow diagram to appear overly crowded or cluttered. To alleviate this problem, the user may select a stub connector element. A stub connector element may be visually connected to the From state element, but only logically connected to the To state element.

A workflow diagram is created, such as by processing element 92 of FIG. 6, in response to the selection and ordering by the user of a plurality of state elements and a plurality of connector elements from the library. See block 12 of FIG. 1. The user will typically identify the inputs and outputs required for the transaction and drag and drop the appropriate type and number of state elements from the library onto an accumulation area (which may be termed a drawing page). As each state element is dropped onto the drawing page, a properties window may be displayed within which properties of the state element may be defined. Each state element will typically be given a unique name to identify the element. The name is typically descriptive of the action that will be taken or the information that will be obtained or displayed. For example, one input state element may be named “InsertCustomerCard.” This input state may correspond to the point in the transaction at which the customer would be instructed to swipe a credit or debit card and the kiosk would receive the account information from the card reader. Variables would then typically be defined for each state element. In one embodiment, as discussed above, input state elements may define input and output variables, output state elements may define only output variables, and transaction state elements may define special transaction state variables (which may include, for example, input and output variables, as well as external reference properties). Each variable will typically be named, and a variable type defined for each variable. As discussed above, several of the variable types (e.g., card reader data, check reader data, PIN pad data, and bar code data) may be used to specify an interaction with a corresponding standardized peripheral device (e.g., card reader, check reader, PIN pad, and bar code reader). Selecting a variable with such a variable type quickly and easily enables a user to add peripheral devices to the kiosk and create the standardized peripheral device interface routine within the kiosk control program to manage the exchange of data with the peripheral device.

Each state element will typically be dropped onto the drawing page with an order and placement generally corresponding to the desired flow of events and actions. Typically, this order and placement will have earlier in time occurring state elements placed at the top of the drawing page and later in time occurring elements placed lower on the drawing page, with optionally occurring state elements placed on the left or right side of the drawing page, in a similar manner as a typical flowchart.

The user will then typically determine the desired transitions to and from each state element, and drag and drop connector elements onto the drawing page. The connector elements will typically be arrow-shaped and have a beginning point and an end point. When a transition is desired from one state element (the From element) to another state element (the To element), the beginning point of the connector element is typically dragged and dropped onto the From element and the end point of the connector element is typically dragged and dropped onto the To element. As discussed above, the user may configure each connector element as either unconditional (e.g., by simply not defining a condition) or conditional (e.g., by defining a condition). In one embodiment, a condition may be set by selecting a connector element and defining a condition within a properties window associated with the connector element. As discussed above, two or more conditions may be defined for a connector element. State elements that are located far apart on the drawing page may be connected by a stub connector, as discussed above.

In one embodiment, a jump state element may also be included in the library and available to be selected. A jump state element may aid a user in the organization of a complicated workflow diagram. A jump state element enables a workflow diagram to be designed on two or more drawing pages, by enabling transitions from one page to another page and back again. A jump state may enable a user to divide the overall workflow diagram into several sub-processes, with each sub-process designed on a separate drawing page. For example, a user may be designing the workflow diagram for a kiosk that will allow customers to make deposits, withdraw cash, check balances, and pay bills. Each of these tasks may be designed as a separate sub-process on a separate drawing page. As such, the use of jump state elements may make it easier to navigate around a complex workflow diagram.

Another optional feature that may aid a user in the organization of a complicated workflow diagram is layering. A layer is typically a named category of state elements. A user may define two or more layers, and then assign each state element to a layer. The user may then select one of the layers to view or print, such that the user will only see the state elements assigned to the selected layer. The user may define a layer for each sub-process, thereby enabling the user to view each sub-process separately.

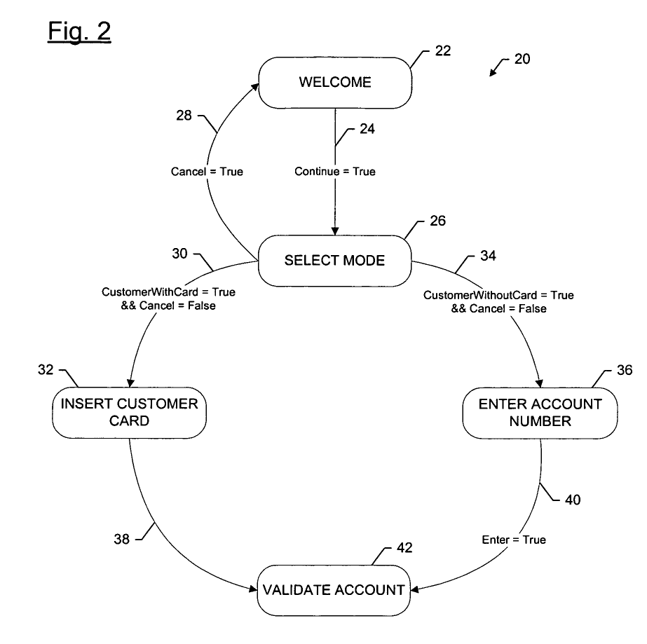

FIG. 2 is an illustration of a partial workflow diagram created by a system for graphically creating a program for controlling operation of a self-service kiosk, according to one embodiment of the invention. Partial workflow diagram 20 comprises state elements 22, 26, 32, 36, and 42. The transitions between state elements are controlled by connector elements 24, 28, 30, 34, 38, and 40. State element 22 may be, for example, an input state element named “Welcome.” Input state element 22 may define an input variable named “Continue” that is of a Boolean variable type. This input variable would typically be set to “true” by the customer pressing a “Continue” button. Input state element 22 may also define an output variable named “WelcomeMessage” that is of a string type. Such an output variable may cause the kiosk screen display to display the message “Welcome to XYZ Payment Systems.” It should be appreciated, however, that text may be displayed without the use of an output variable, such as by adding text during creation of the actual screen display as discussed below. The connector element 24 is a conditional connector element, such that the transition to state element 26 occurs when input variable “Continue” is true.

State element 26 may be an input state element named “SelectMode.” Input state, element 26 may define an input variable named “CustomerWithCard” that is of a Boolean variable type. This input variable would typically be set to “true” by the customer pressing an “I have my card” button. Input state element 26 may also define an input variable named “CustomerWithoutCard” that is of a Boolean variable type. This input variable would typically be set to “true” by the customer pressing an “I do not have my card” button. Input state element 26 may define an input variable named “Cancel” that is of a Boolean variable type. This input variable would typically be set to “true” by the customer pressing a “Cancel” button. Input state element 26 may also define an output variable named “CardChoiceMessage” that is of a string type. Such an output variable may cause the kiosk screen display to display the message “Please indicate whether you have your card with you today.” State element 26 may transition to one of three different state elements, depending on conditional connector elements 28, 30, and 34. If the input variable “Cancel” is true, the workflow diagram will transition back to state element 22 according to connector element 28. If the input variable “CustomerWithCard” is true and the input variable “Cancel” is false, the workflow diagram will transition to state element 32 according to connector element 30. If the input variable “CustomerWithoutCard” is true and the input variable “Cancel” is false, the workflow diagram will transition to state element 36 according to connector element 34.

State element 32 may be an input state element named “InsertCustomerCard.” Input state element 32 may define an input variable named “CardReader” that is of a card reader variable type. Importantly, this input variable type may be used to specify an interaction with a standardized card reader peripheral device and enable the creation of a standardized peripheral device interface routine within the kiosk control program. Input state element 32 may also define an output variable named “InsertCard” that is of a string type. Such an output variable may cause the kiosk screen display to display the message “Please insert your credit or debit card.” When the customer inserts a credit or debit card, the card reader will read the data encoded on the magnetic strip and send the data to the processing element. The workflow diagram will then transition to state element 42 according to connector element 38.

State element 36 may be an input state element named “EnterAccountNumber.” Input state element 36 may define an input variable named “AccountNumber” that is of a string variable type for receiving the customer's account number. Input state element 36 may also define an input variable named “Enter” that is of a Boolean variable type. This input variable would typically be set to “true” by the customer pressing an “Enter” button, typically after entering an account number. Input state element 36 may also define an output variable named “AccountNumberMessage” that is of a string type. Such an output variable may cause the kiosk screen display to display the message “Please enter your account number, then press ‘Enter.’” If the input variable “Enter” is true, the workflow diagram will transition to state element 42 according to connector element 40.

State element 42 may be a transaction state element named “ValidateAccount.” The transaction state element 42 will typically define two default result variables: success and valid. The success variable indicates whether the backend server was able to receive the variable (e.g., the account number) sent from the kiosk and check the validity (e.g., whether the account number sent from the kiosk is recognized by the backend server as an account number that can be checked). The valid variable indicates whether the variable sent from the kiosk is determined by the backend server to be valid (e.g., whether the checked account number corresponds to a valid account). Both of these default result variables will typically have a variable type of Boolean. The external reference variable typically defines a name or GUID of the backend server (e.g., “ValidationServer”). The external service variable typically defines the action that the backend server will take (e.g., “CheckAccount”). Although no transition from state element 42 is shown, a typical workflow diagram would have many more state elements and connector elements than is illustrated in FIG. 2.

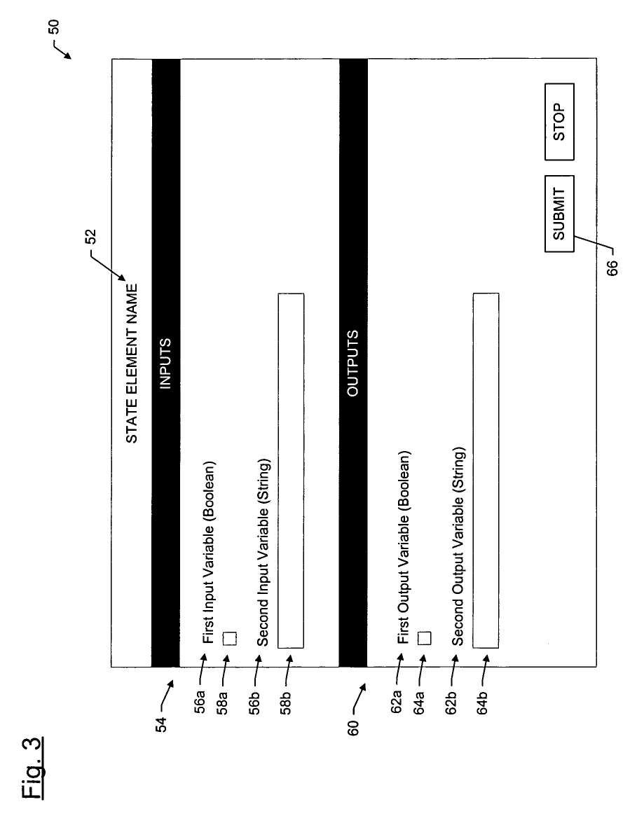

By the selection and placement of the appropriate state elements, and the connection of the state elements using unconditional and conditional connector elements, the user may design a workflow diagram that corresponds to the desired sequence of events, actions, and screen displays on the kiosk. When the workflow diagram is complete, a screen flow simulation may be created, such as by processing element 92 of FIG. 6, comprising simulated kiosk screen displays. See block 14 of FIG. 1. The screen flow simulation replicates the operation of the kiosk, thus enabling the user to test the planned operation prior to creating the final screen displays. Prior to the creation of the screen flow simulation, an error check may be performed on the workflow diagram. The error check may look for many different types of errors, such as duplicate variable names and disconnected connector elements. If the error check does not identify any errors, the screen flow simulation may be created. The screen flow simulation provides the ability for the user to verify that the specified sequence of events, actions, and screen displays will provide the desired functionality and the desired ease of use. Each state element in the workflow diagram will typically have a corresponding simulated screen display. The simulated screen displays may be created using HTML, Microsoft .NET™, or any other suitable software application. The sequence of display of the simulated screen displays would typically be controlled by an extensible Markup Language (XML) program that is created, such as by processing element 92 of FIG. 6, at approximately the same time the simulated screen displays are created. FIG. 3 is an illustration of a template for a screen display simulation created by a system for graphically creating a program for controlling operation of a self-service kiosk, according to one embodiment of the invention. As illustrated in FIG. 3, the template 50 will typically include the name of the state element 52, an area 54 to display the input variables, and an area 60 to display the output variables. FIG. 3 illustrates the display of two input variable names 56a, 56b, and corresponding areas 58a, 58b for the user to input data for these variables for testing purposes. As the first input variable 56a is illustrated as a Boolean variable, the corresponding input area 58a is a check box, enabling the user to check the box to set the variable to “true.” As the second input variable 56b is illustrated as a string variable, the corresponding input area 58b is a text box, enabling the user to input a string of data such as an account number for testing. FIG. 3 also illustrates the display of two output variable names 62a, 62b, and areas 64a, 64b to display the data corresponding to these variables. As the first output variable 62a is illustrated as a Boolean variable, the corresponding output area 64a is a check box, such that the check box would typically appear checked if the variable is “true.” As the second output variable 62b is illustrated as a string variable, the corresponding output area 64b is a text box, such that text data may be displayed during testing. During testing, the user may view the data in the output variables, input test data in the input variables, and then advance to the next simulated screen display (such as by pressing the “submit” button 66).

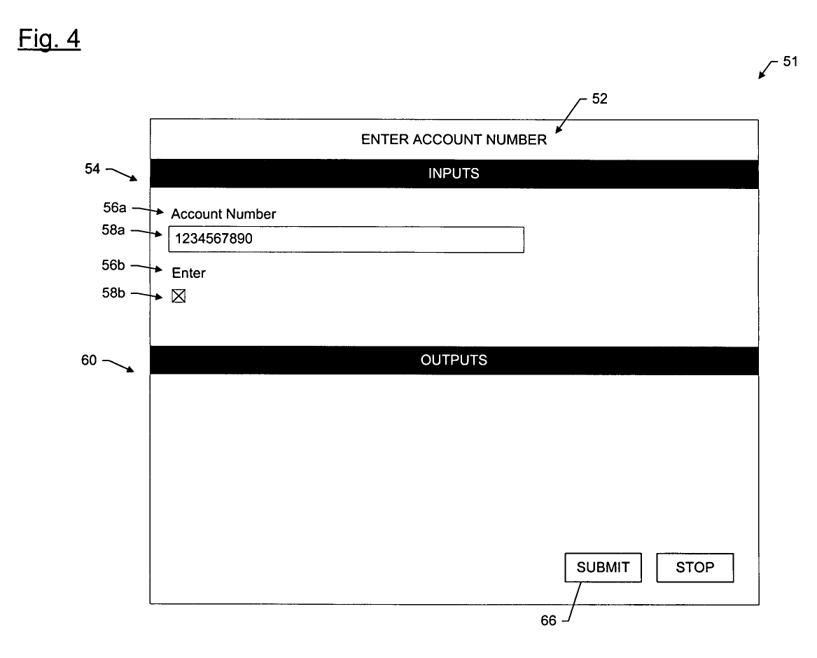

FIG. 4 is an illustration of a screen display simulation created by a system for graphically creating a program for controlling operation of a self-service kiosk, according to one embodiment of the invention. Simulated screen display 51 displays the name 52 of the state element (“Enter Account Number”), two input variables 56a, 56b, and no output variables. FIG. 4 illustrates that the user has entered an account number (“1234567890”) into area 58a for testing purposes and has checked box 58b to simulate the customer pressing an “Enter” button.

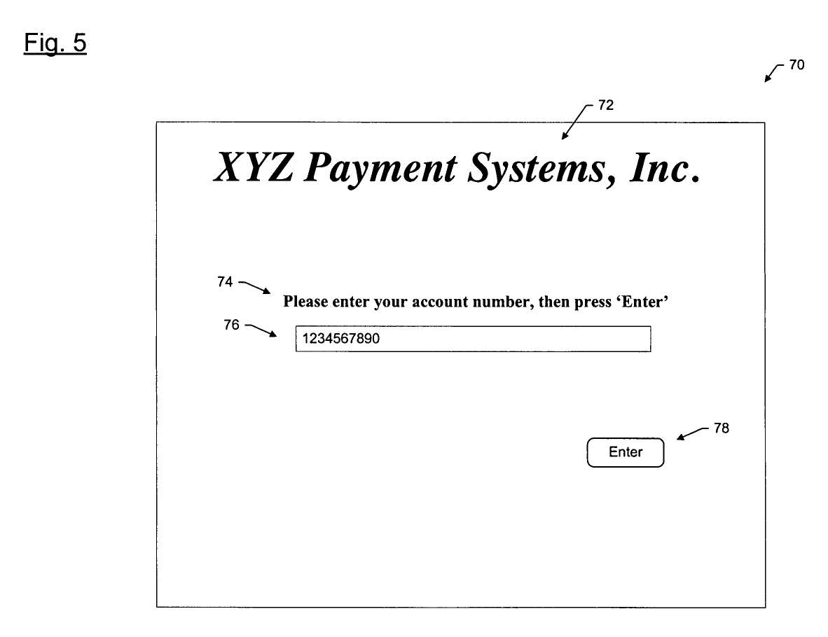

The user would typically step through the screen display simulation many different times, each time selecting different options (typically by entering different data into the input variables) to test all possible sequences of screen displays. When the user is satisfied with the screen flow simulation, the program for controlling operation of the kiosk may be created, such as by processing element 92 of FIG. 6. See block 16 of FIG. 1. The program may be created using any suitable programming language, such as a language conforming to the XFS programming standard. The standardized peripheral device interface routines that manage the exchange of data with the peripheral devices would, in particular, typically be created using a programming language conforming to the XFS programming standard. The created screen displays can be graphically enhanced, such as by adding graphics, to create the desired visual appearance. FIG. 5 is an illustration of an actual screen display created from the simulated screen display of FIG. 4, according to one embodiment of the invention. The actual screen display 70 illustrates the addition of graphics, in this case the logo 72 of the kiosk owner. Additional text 74 has been added to provide clearer instructions to the customer. The check box for the “Enter” input variable has been changed to a touch screen button 78. The created program may be transferred to one or more kiosks, such as via a network, for storage and execution on the kiosk.

FIG. 6 is a schematic block diagram of a system for graphically creating a program for controlling operation of a self-service kiosk, according to one embodiment of the invention. The system 90 comprises a processing element 92, a display element 94, and a storage element 96. As discussed above, the processing element 92 may provide a library of state elements and connector elements for the user to select. The processing element 92 may create a workflow diagram in response to the selection and ordering of state elements and connector elements from the library. The processing element may create a screen flow simulation corresponding to the workflow diagram. The processing element may create the program for controlling operation of the kiosk in response to the user's acceptance of the screen flow simulation. The display element 94 may display the library of state elements and connector elements, the workflow diagram, the simulated screen displays, and the actual screen displays. The storage element 96 may store the library of state elements and connector elements, the created workflow diagram, the simulated screen displays, the actual screen displays, and the kiosk control program. When finalized, the kiosk control program may be transmitted, such as via network 98, to one or more kiosks 100. The kiosk control program may be stored and executed at the kiosk.

According to one aspect of the invention, all or a portion of the system of the invention generally operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

In this regard, FIG. 1 is a flowchart of methods, systems and program products according to the invention. It will be understood that each block or step of the flowchart, and combinations of blocks in the flowchart, can be implemented by computer program instructions. These computer program instructions may be loaded onto a computer or other programmable apparatus to produce a machine, such that the instructions which execute on the computer or other programmable apparatus create means for implementing the functions specified in the flowchart block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart block(s) or step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the flowchart block(s) or step(s).

Accordingly, blocks or steps of the flowchart support combinations of means for performing the specified functions, combinations of steps for performing the specified functions and program instruction means for performing the specified functions. It will also be understood that each block or step of the flowchart, and combinations of blocks or steps in the flowchart, can be implemented by special purpose hardware-based computer systems which perform the specified functions or steps, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A system for graphically creating a program for controlling operation of a kiosk, the system comprising:
a processing element capable of providing a library of state elements and connector elements, each state element selected from the group comprising an input state and an output state, each input state defining a receipt of data from a source that is external to the kiosk, each input state further defining at least one input variable having an input variable type, each output state defining a provision of data to a recipient that is external to the kiosk, each output state further defining at least one output variable having an output variable type, each connector element selected from the group comprising an unconditional connector and a conditional connector and defining a transition from a first state element to a second state element;
the processing element further capable of creating a workflow diagram in response to a selection and ordering by a user of a plurality of state elements and a plurality of connector elements, the workflow diagram representing a desired operation of the kiosk;
the processing element further capable of creating a screen flow simulation corresponding to the workflow diagram, the screen flow simulation comprising a plurality of simulated kiosk screen displays, each simulated kiosk screen display corresponding to either an input state element or an output state element in the workflow diagram; and
the processing element further capable of creating the program for controlling operation of the kiosk in response to an acceptance by the user of the screen flow simulation, the program comprising actual kiosk screen displays capable of being graphically enhanced.

2. The system of claim 1, wherein each state element is selected from the group further comprising a transactional state, wherein each transactional state defines a communication with a centralized support system; and wherein each simulated kiosk screen display corresponds to an input state element, an output state element, or a transactional state element in the workflow diagram.

3. The system of claim 2, wherein the centralized support system is capable of performing at least one of verifying user account status, verifying a user personal identification number (PIN), and providing user account information.

4. The system of claim 1, wherein each input state further defines at least one output variable having an output variable type.

5. The system of claim 1, wherein the input variable type and the output variable type are both selected from the group comprising integer, string, Boolean, floating point, globally unique identifier (GUID), card reader data, check reader data, pin pad data, and bar code data.

6. The system of claim 5, wherein the program for controlling operation of the kiosk further comprises a standardized peripheral device interface routine if the input variable type is card reader data, check reader data, pin pad data, or bar code data.

7. The system of claim 6, wherein the processing element creates the standardized peripheral device interface routine using an extensions for financial services (XFS) software standard.

8. The system of claim 1, wherein the conditional connector defines at least one input variable condition or at least one output variable condition, wherein the input or output variable condition defines under what condition the first state element transitions to the second state element.

9. A method of graphically creating a program for controlling operation of a kiosk, the method comprising:
providing a library of state elements and connector elements, each state element selected from the group comprising an input state and an output state, each input state defining a receipt of data from a source that is external to the kiosk, each input state further defining at least one input variable having an input variable type, each output state defining a provision of data to a recipient that is external to the kiosk, each output state further defining at least one output variable having an output variable type, each connector element selected from the group comprising an unconditional connector and a conditional connector and defining a transition from a first state element to a second state element;
creating a workflow diagram in response to a selection and ordering by a user of a plurality of state elements and a plurality of connector elements, the workflow diagram representing a desired operation of the kiosk;
creating a screen flow simulation corresponding to the workflow diagram, the screen flow simulation comprising a plurality of simulated kiosk screen displays, each simulated kiosk screen display corresponding to either an input state element or an output state element in the workflow diagram; and
creating the program for controlling operation of the kiosk in response to an acceptance by the user of the screen flow simulation, the program comprising actual kiosk screen displays capable of being graphically enhanced.

10. The method of claim 9, wherein each state element is selected from the group further comprising a transactional state, wherein each transactional state defines a communication with a centralized support system; and wherein each simulated kiosk screen display corresponds to an input state element, an output state element, or a transactional state element in the workflow diagram.

11. The method of claim 10, wherein the centralized support system is capable of performing at least one of verifying user account status, verifying a user personal identification number (PIN), and providing user account information.

12. The method of claim 9, wherein each input state further defines at least one output variable having an output variable type.

13. The method of claim 9, wherein the input variable type and the output variable type are both selected from the group comprising integer, string, Boolean, floating point, globally unique identifier (GUID), card reader data, check reader data, pin pad data, and bar code data.

14. The method of claim 13, wherein the program for controlling operation of the kiosk further comprises a standardized peripheral device interface routine if the input variable type is card reader data, check reader data, pin pad data, or bar code data.

15. The method of claim 14, wherein the standardized peripheral device interface routine is created using an extensions for financial services (XFS) software standard.

16. The method of claim 9, wherein the conditional connector defines at least one input variable condition or at least one output variable condition, wherein the input or output variable condition defines under what condition the first state element transitions to the second state element.

17. A computer program product for graphically creating a program for controlling operation of a kiosk, the computer program product comprising at least one computer-readable storage medium having computer-readable program code portions stored therein, the computer-readable program code portions comprising:
a first executable portion capable of providing a library of state elements and connector elements, each state element selected from the group comprising an input state and an output state, each input state defining a receipt of data from a source that is external to the kiosk, each input state further defining at least one input variable having an input variable type, each output state defining a provision of data to a recipient that is external to the kiosk, each output state further defining at least one output variable having an output variable type, each connector element selected from the group comprising an unconditional connector and a conditional connector and defining a transition from a first state element to a second state element;
a second executable portion capable of creating a workflow diagram in response to a selection and ordering by a user of a plurality of state elements and a plurality of connector elements, the workflow diagram representing a desired operation of the kiosk;
a third executable portion capable of creating a screen flow simulation corresponding to the workflow diagram, the screen flow simulation comprising a plurality of simulated kiosk screen displays, each simulated kiosk screen display corresponding to either an input state element or an output state element in the workflow diagram; and
a fourth executable portion capable of creating the program for controlling operation of the kiosk in response to an acceptance by the user of the screen flow simulation, the program comprising actual kiosk screen displays capable of being graphically enhanced.

18. The computer program product of claim 17, wherein each state element is selected from the group further comprising a transactional state, wherein each transactional state defines a communication with a centralized support system; and wherein each simulated kiosk screen display corresponds to an input state element, an output state element, or a transactional state element in the workflow diagram.

19. The computer program product of claim 18, wherein the centralized support system is capable of performing at least one of verifying user account status, verifying user a personal identification number (PIN), and providing user account information.

20. The computer program product of claim 17, wherein each input state further defines at least one output variable having an output variable type.

21. The computer program product of claim 17, wherein the input variable type and the output variable type are both selected from the group comprising integer, string, Boolean, floating point, globally unique identifier (GUID), card reader data, check reader data, pin pad data, and bar code data.

22. The computer program product of claim 21, wherein the program for controlling operation of the kiosk further comprises a standardized peripheral device interface routine if the input variable type is card reader data, check reader data, pin pad data, or bar code data.

23. The computer program product of claim 22, wherein the standardized peripheral device interface routine is created using an extensions for financial services (XFS) software standard.

24. The computer program product of claim 17, wherein the conditional connector defines at least one input variable condition or at least one output variable condition, wherein the input or output variable condition defines under what condition the first state element transitions to the second state element.

25. A method of graphically creating a program for controlling operation of a kiosk, the method comprising:
providing a library of state elements and connector elements, each state element selected from the group comprising an input state and an output state, each input state defining a receipt of data from a source that is external to the kiosk, each input state further defining at least one input variable having an input variable type, each input variable type selected from the group comprising integer, string, Boolean, floating point, globally unique identifier (GUID), card reader data, check reader data, pin pad data, and bar code data, each output state defining a provision of data to a recipient that is external to the kiosk, each output state further defining at least one output variable having an output variable type, each connector element selected from the group comprising an unconditional connector and a conditional connector and defining a transition from a first state element to a second state element;
creating a workflow diagram in response to a selection and ordering by a user of a plurality of state elements and a plurality of connector elements, the workflow diagram representing a desired operation of the kiosk;
creating a screen flow simulation corresponding to the workflow diagram, the screen flow simulation comprising a plurality of simulated kiosk screen displays, each simulated kiosk screen display corresponding to either an input state element or an output state element in the workflow diagram; and
creating the program for controlling operation of the kiosk in response to an acceptance by the user of the screen flow simulation, the program comprising actual kiosk screen displays capable of being graphically enhanced, the program further comprising a standardized peripheral device interface routine if the input variable type is card reader data, check reader data, pin pad data, or bar code data.

26. The method of claim 25, wherein the standardized peripheral device interface routine is created using an extensions for financial services (XFS) software standard.
